(19) United States
(12) Patent Application Publication
(10) Pub. No.: US 2013/0138581 A1
(43) Pub. Date: May 30, 2013

(54) Feedback method for promoting consumption

(71) Applicant: Ds-Ying Wang, Kaohsiung City (TW)

(72) Inventor: Ds-Ying Wang, Kaohsiung City (TW)

(21) Appl. No.: 13/306,880

(22) Filed: Nov. 29, 2011

(51) Int. Cl. G06Q 90/00

(52) U.S. Cl. 705/500

(57) ABSTRACT

A feedback method for promoting consumption includes providing a feedback rule, providing an ABC vein principle, providing a manufacturer alliance principle, providing a co-branded card system, and providing a network construction. Thus, the feedback method builds a system of a merchandise discount and a sale feedback bonus to increase the personal connection vein and the affiliated manufacturers and to connect the supply of the production terminal and the demand of the consumer terminal so as to decrease the cost of products and to increase the demand for products such that the consumers can purchase cheaper products, and the manufacturers can obtain more orders.

### BACKGROUND OF THE INVENTION

1. Field of the Invention

The present invention relates to a method and, more particularly, to a feedback method for promoting consumption of consumers.

2. Description of the Related Art

In a map diary website, people can join the website to form a consumer group that can negotiate a product requirement with a manufacturer so as to achieve a merchandise discount. Thus, the consumers can purchase cheaper products when the consumer group reaches a determined number, and the manufacturer can obtain more orders so that the supply of the production terminal and the demand of the consumer terminal has a better connection to decrease the cost of products for the consumers and to increase the income of the manufacturer. However, the consumer group has a limited number, and the feedback system is limited to a merchandise discount.

### BRIEF SUMMARY OF THE INVENTION

In accordance with the present invention, there is provided a feedback method for promoting consumption, comprising a first step of providing a feedback rule which distributes a predetermined feedback reward to a protagonist who proceeds a commercial sell and achieves an economical profit in a personal connection vein, a second step of providing an ABC vein principle which builds a primary framework of the personal connection vein, a third step of providing a manufacturer alliance principle which builds a system of a merchandise discount and a sale feedback bonus for an affiliated manufacturer, a fourth step of providing a co-branded card system in which a person who joins the personal connection vein can use an identified credit card after passing a credit check, and a fifth step of providing a network construction which includes all details of a manufacturer discount program, a personal connection vein application and a co-branded credit card.

Preferably, the ABC vein principle includes a mother generation A member, a plurality of B members who are subordinate to the mother generation A member, and a plurality of C members who are subordinate to the B members respectively.

Preferably, the mother generation A member is the protagonist in the personal connection vein of the first step of the feedback method.

Preferably, the third step of providing a manufacturer alliance principle further includes using a power of a consumer group so as to drive the affiliated manufacturer to join the personal connection vein and providing a merchandise discount system so as to increase the personal connection vein.

Preferably, the fourth step of providing a co-branded card system further includes finishing all consumption through the identified credit card.

Preferably, each of the B members is found or agreed by the mother generation A member, and each of the C members is found or agreed by a respective one of the B members.

Thus, the feedback method in accordance with the present invention mainly has the feature of a demand consumption manner so that the consumers construct a consumer group which can negotiate a group requirement with the manufacturer to achieve a merchandise discount and a sale feedback bonus for an affiliated manufacturer so as to attract more people and manufacturers to join the personal connection vein through the consumption feedback system, thereby forming a mutual economical connection between the consumers and the manufacturers.

According to the primary advantage of the present invention, the feedback method builds a system of a merchandise discount and a sale feedback bonus to increase the personal connection vein and the affiliated manufacturers and to connect the supply of the production terminal and the demand of the consumer terminal so as to decrease the cost of products and to increase the demand for products such that the consumers can purchase cheaper products, and the manufacturers can obtain more orders.

According to another advantage of the present invention, the personal connection vein is increased by the feedback reward of the feedback rule and the merchandise discount of the manufacturer alliance principle, and the affiliated manufacturers are increased when the personal connection vein is increased so that the personal connection vein and the affiliated manufacturers are interacted and increased reciprocally so as to form a feedback system, thereby decreasing the cost of products and increasing the demand for products.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of an ABC vein principle of a feedback method for promoting consumption in accordance with the preferred embodiment of the present invention.

FIG. 2 is a tree graph of the ABC vein principle of the feedback method as shown in FIG. 1.

FIG. 3 is a calculation chart to illustrate the feedback reward of the feedback rule of the feedback method in accordance with the preferred embodiment of the present invention.

### DETAILED DESCRIPTION OF THE INVENTION

The present invention is to provide a feedback method for promoting consumption of consumers, comprising a first step of providing a feedback rule which distributes a predetermined feedback reward to a protagonist who proceeds a commercial sell and achieves an economical profit in a personal connection vein, a second step of providing an ABC vein principle which builds a primary framework of the personal connection vein, a third step of providing a manufacturer alliance principle which builds a system of a merchandise discount and a sale feedback bonus for an affiliated manufacturer, a fourth step of providing a co-branded card system in which a person who joins the personal connection vein can use an identified credit card after passing a credit check, and a fifth step of providing a network construction which includes all details of a manufacturer discount program, a personal connection vein application and a co-branded credit card. The third step of providing a manufacturer alliance principle further includes using a power of a consumer group so as to drive the affiliated manufacturer to join the personal connection vein and providing a merchandise discount system so as to increase the personal connection vein. The fourth step of providing a co-branded card system further includes finishing all consumption through the identified credit card.

Thus, the feedback method in accordance with the present invention mainly has the feature of a demand consumption manner so that the consumers construct a consumer group which can negotiate a group requirement with the manufacturer to achieve a merchandise discount and a sale feedback bonus for an affiliated manufacturer so as to attract more people and manufacturers to join the personal connection vein through the consumption feedback system, thereby forming a mutual economical connection between the consumers and the manufacturers.

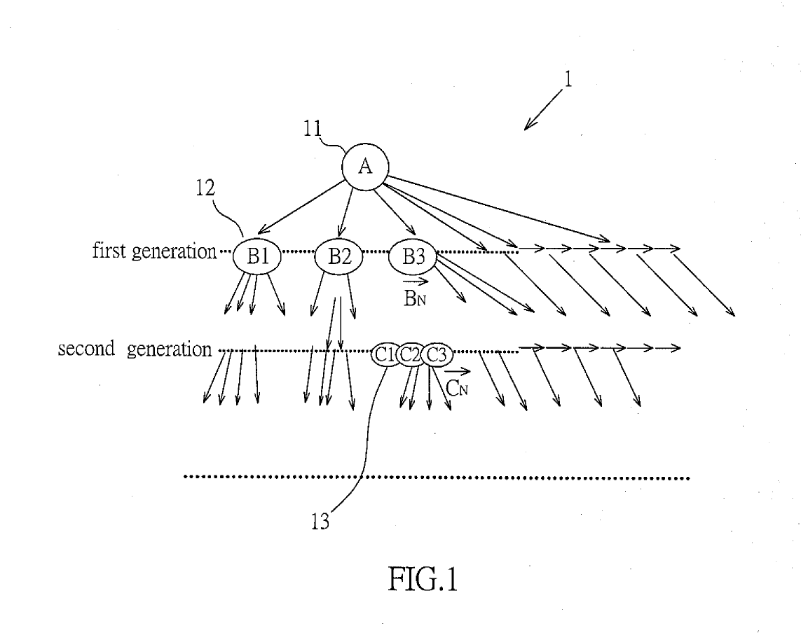

Referring to the drawings and initially to FIG. 1, the ABC vein principle 1 in accordance with the preferred embodiment of the present invention includes a mother generation A member 11, a plurality of B (B1, B2, B3 and etc.) members 12 who are subordinate to the mother generation A member 11, and a plurality of C (C1, C2, C3 and etc.) members 13 who are subordinate to the B members 12 respectively.

In the preferred embodiment of the present invention, the mother generation A member 11 is the protagonist in the personal connection vein of the first step of the feedback method. In addition, each of the B members 12 is found or agreed by the mother generation A member 11, and each of the C members 13 is found or agreed by a respective one of the B members 12.

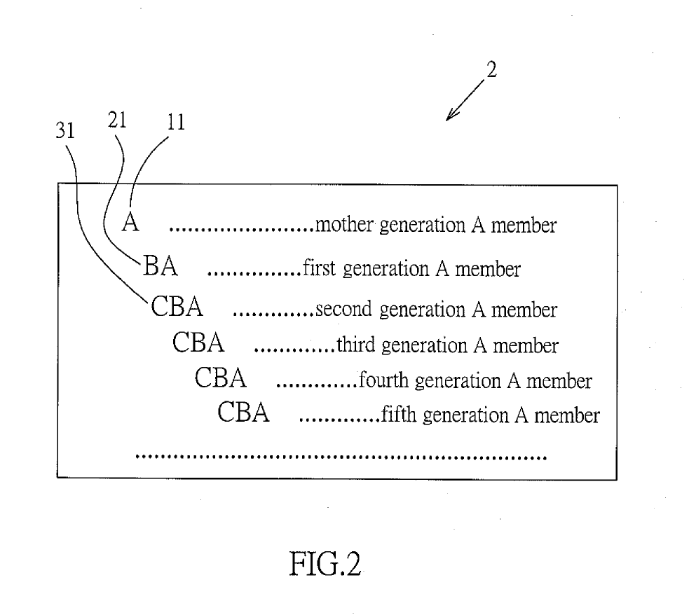

Referring to FIG. 2 with reference to FIG. 1, the ABC vein principle 1 in accordance with the preferred embodiment of the present invention is illustrated by a tree graph 2. The tree graph 2 includes the mother generation A member 11, a plurality of first generation A members 21, and a plurality of second generation A members 31. Each of the first generation A members 21 consists of the mother generation A member 11 and the respective B member 12 and is indicated by “BA”. Each of the second generation A members 31 consists of the mother generation A member 11, the respective B member 12 and the respective C member 13 and is indicated by “CBA”.

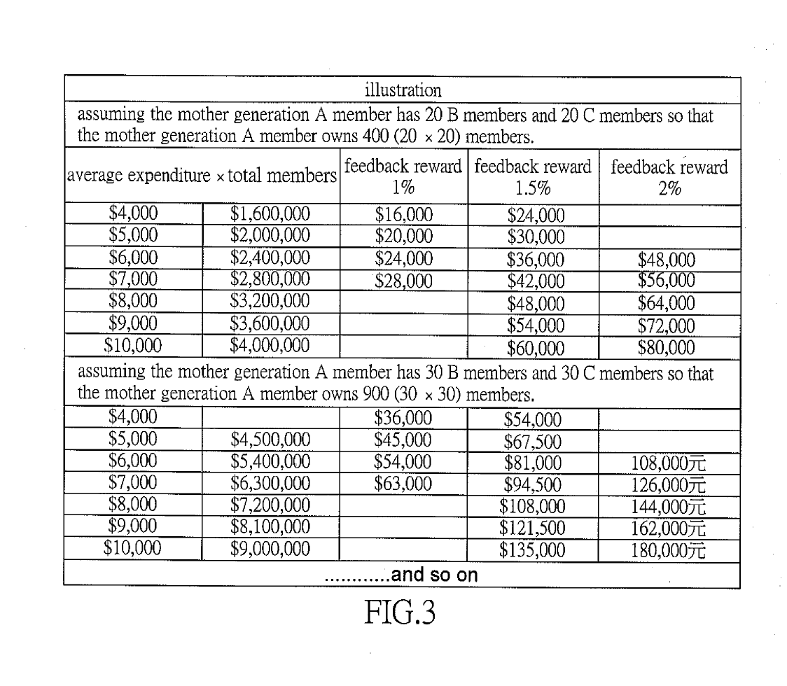

Referring to FIG. 3 with reference to FIGS. 1 and 2, a calculation chart is shown to illustrate the predetermined feedback reward of the feedback rule of the first step of the feedback method in accordance with the preferred embodiment of the present invention.

In practice, the total expenditure is equal to the average expenditure multiplying the total members owned by the mother generation A member 11, and the feedback reward of the feedback rule is equal to a predetermined ratio of the total expenditure.

It is assumed that the mother generation A member 11 has twenty (20) B members 12 and twenty (20) C members 13 so that the mother generation A member 11 owns four hundred (20×20=400) members. Thus, if the average expenditure is 4,000 dollars and the total members owned by the mother generation A member 11 are 400, the total expenditure is equal to 1,600,000 (4,000×400) dollars. Then, if the feedback reward of the feedback rule is one percent (1%), the feedback reward that will be given to the protagonist is equal to 16,000 (1,600,000×1%) dollars.

Alternatively, it is assumed that the mother generation A member 11 has thirty (30) B members 12 and thirty (30) C members 13 so that the mother generation A member 11 owns nine hundred (30×30=900) members. Thus, if the average expenditure is 4,000 dollars and the total members owned by the mother generation A member 11 are 900, the total expenditure is equal to 3,600,000 (4,000×900) dollars. Then, if the feedback reward of the feedback rule is one percent (1%), the feedback reward that will be given to the protagonist is equal to 36,000 (3,600,000×1%) dollars.

Accordingly, the feedback method builds a system of a merchandise discount and a sale feedback bonus to increase the personal connection vein and the affiliated manufacturers and to connect the supply of the production terminal and the demand of the consumer terminal so as to decrease the cost of products and to increase the demand for products such that the consumers can purchase cheaper products, and the manufacturers can obtain more orders. In addition, the personal connection vein is increased by the feedback reward of the feedback rule and the merchandise discount of the manufacturer alliance principle, and the affiliated manufacturers are increased when the personal connection vein is increased so that the personal connection vein and the affiliated manufacturers are interacted and increased reciprocally so as to form a feedback system, thereby decreasing the cost of products and increasing the demand for products.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A feedback method for promoting consumption, comprising:
a first step of providing a feedback rule which distributes a predetermined feedback reward to a protagonist who proceeds a commercial sell and achieves an economical profit in a personal connection vein;
a second step of providing an ABC vein principle which builds a primary framework of the personal connection vein;
a third step of providing a manufacturer alliance principle which builds a system of a merchandise discount and a sale feedback bonus for an affiliated manufacturer;
a fourth step of providing a co-branded card system in which a person who joins the personal connection vein can use an identified credit card after passing a credit check; and
a fifth step of providing a network construction which includes all details of a manufacturer discount program, a personal connection vein application and a co-branded credit card.

2. The feedback method of claim 1, wherein the ABC vein principle includes:
a mother generation A member;
a plurality of B members who are subordinate to the mother generation A member; and
a plurality of C members who are subordinate to the B members respectively.

3. The feedback method of claim 2, wherein the mother generation A member is the protagonist in the personal connection vein of the first step of the feedback method.

4. The feedback method of claim 1, wherein the third step of providing a manufacturer alliance principle further includes:
using a power of a consumer group so as to drive the affiliated manufacturer to join the personal connection vein; and
providing a merchandise discount system so as to increase the personal connection vein.

5. The feedback method of claim 1, wherein the fourth step of providing a co-branded card system further includes finishing all consumption through the identified credit card.

6. The feedback method of claim 2, wherein
each of the B members is found or agreed by the mother generation A member; and
each of the C members is found or agreed by a respective one of the B members.
